(19) United States
(12) Patent Application Publication
(10) Pub. No.: US 2010/0123923 A1
(43) Pub. Date: May 20, 2010

(54) IMAGE FORMING APPARATUS, METHOD OF TRANSFERRING IMAGE DATA, AND COMPUTER PROGRAM PRODUCT

(76) Inventors: Hiroyuki Katoh, Tokyo (JP); Hidenori Shindoh, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/579,590

(22) Filed: Oct. 15, 2009

(30) Foreign Application Priority Data
Nov. 19, 2008 (JP) 2008-296032

(51) Int. Cl. G06F 3/12

(52) U.S. Cl. 358/1.15

(57) ABSTRACT

An image forming apparatus includes a storage section to store compressed data obtained by compressing image data, an output image memory having a deployment area in which the compressed data transferred from the storage section are deployed, a transferring control section to control transferring of the compressed data from the storage section to the output image memory, an expansion section to obtain the compressed data deployed in the deployment area of the output image memory to expand the obtained compressed data, and a print engine to which the expanded data are supplied. In the mage forming apparatus, the transferring control section controls the transferring of the compressed data to be transferred from the storage section to the output image memory based on capacity of the deployment area of the output image memory and a size of the compressed data.

### BACKGROUND OF THE INVENTION

1. Field of the Invention

The present invention generally relates to an image forming apparatus, a method of transferring image data, and a program product for causing a computer to implement the method of transferring image data.

2. Description of the Related Art

Along with an increase in performance of a CPU (Central Processing Unit), an increase in the capacity of a memory, and an increase in speeds of communications technology, a recent multi-functional peripheral (MFP) incorporates the functionality of multiple devices, such as a digital copier, a facsimile (FAX), a printer and a scanner, in one, and the MFP (hereinafter also called as an “image forming apparatus”) is becoming widely used in various user environments.

In such an image forming device, however, the size of image data is sometimes too large to be stored in a built-in memory (e.g., main memory) while a document is being printed. To overcome such a challenge, Japanese Patent Application Laid-Open No. 2006-129279 has disclosed a technology in which the image data are divided into segments to be stored in a storage region (i.e., external storage such as HDD or SD memory card) so that the image data having a size larger than the main memory can be printed. More specifically, with the disclosed technology, the image data are divided into segments each having a predetermined size, and the segments of the image data are stored in an input memory. The image data segments are then compressed to be temporarily stored in an accumulation memory. Thereafter, the stored image data segments are retrieved from the accumulation memory and expanded (decompressed) in an output memory to thereby print the image data.

However, with such a related art technology, since the image data segments retrieved from the accumulation memory are still expanded or decompressed in the output memory and the expanded data are output from the output image memory to a print engine, the size of the image data is still relied on or limited by the capacity of the output memory. That is, the expanded image data are deployed in the output memory in the disclosed technology. Accordingly, if the size of the image data is too large to be held in the output memory, the disclosed technology may not be the most optimal one in order to increase processing speed or efficient processing in the memory.

### SUMMARY OF THE INVENTION

Accordingly, embodiments of the present invention may provide a novel and useful image forming apparatus, method of transferring image data, and program product for causing a computer to implement the method of transferring image data solving one or more of the problems discussed above. More specifically, the embodiments of the present invention may provide an image forming apparatus, a method of transferring image data, and a program product for causing a computer to implement the method of transferring image data in which the image data to be output are compressed (coded) to be handled in the output image memory, and the coded data (codes) are expanded after the codes have been output from the output image memory and the expanded codes are then supplied to the print engine, thereby improving efficiency in printing the image data.

According to an embodiment of the invention, there is provided an image forming apparatus that includes a storage section configured to store first compressed data obtained by compressing image data, a first output image memory having a deployment area in which the first compressed data transferred from the storage section are deployed, a transferring control section configured to control transferring of the first compressed data from the storage section to the first output image memory, an expansion section configured to obtain the first compressed data deployed in the deployment area of the first output image memory to expand the obtained first compressed data, and a print engine to which the expanded data expanded by the expansion section are supplied. In the image forming apparatus, the transferring control section controls the transferring of the first compressed data to be transferred from the storage section to the first output image memory based on capacity of the deployment area of the first output image memory and a size of the first compressed data.

According to an embodiment of the invention, there is provided a method of transferring image data in an image forming apparatus including a storage section configured to store compressed data obtained by compressing image data, an output image memory having a deployment area in which the compressed data transferred from the storage section are deployed, and a print engine. The method includes controlling transferring of the compressed data based on capacity of the deployment area of the output image memory and a size of the compressed data from the storage section to the output image memory, expanding the compressed data retrieved from the deployment area of the output image memory, and supplying the expanded data to the print engine.

According to an embodiment of the invention, there is provided a computer-readable program product for causing a computer to implement the aforementioned method of transferring image data.

### BRIEF DESCRIPTION OF THE DRAWINGS

FIG. 1 is a configuration diagram of an image forming apparatus according to an embodiment of the invention;

FIG. 2 is a hardware configuration diagram of the image forming apparatus according to the embodiment of the invention;

FIG. 3 is a diagram illustrating a data flow when image data are input to and output from in the image forming apparatus according to the embodiment of the invention;

FIG. 4 is a diagram illustrating an application-specific integrated circuit (hereinafter abbreviated as “ASIC”) in the image forming apparatus according to the embodiment of the invention;

FIG. 5 is a diagram illustrating a process in which the image data are compressed and stored in an accumulation region in the image forming apparatus according to the embodiment of the invention;

FIG. 6 is a diagram illustrating a process in which the compressed data stored in the accumulation region are deployed in an output image memory in the image forming apparatus according to the embodiment of the invention;

FIG. 7 is a flowchart illustrating a process in which the number of compressed data to be transferred to the output image memory is computed;

FIG. 8 is a diagram illustrating a profile in which the number of compressed data (codes) to be transferred is determined;

FIG. 9 is a diagram illustrating one example of a process in which codes are sequentially processed;

FIG. 10 is a diagram illustrating a process in which the compressed data are read from the output image memory and output to a print engine;

FIG. 11 is a diagram illustrating one example of a process in which an image memory handler (hereinafter, abbreviated as “IMH”) manages progress of output processing;

FIG. 12 is a diagram illustrating another example (modification 1) of the process in which the image memory handler manages progress of output processing; and

FIG. 13 is a diagram illustrating still another example (modification 2) of the process in which the image memory handler manages progress of output processing.

### DETAILED DESCRIPTION OF THE PREFERRED EMBODIMENTS

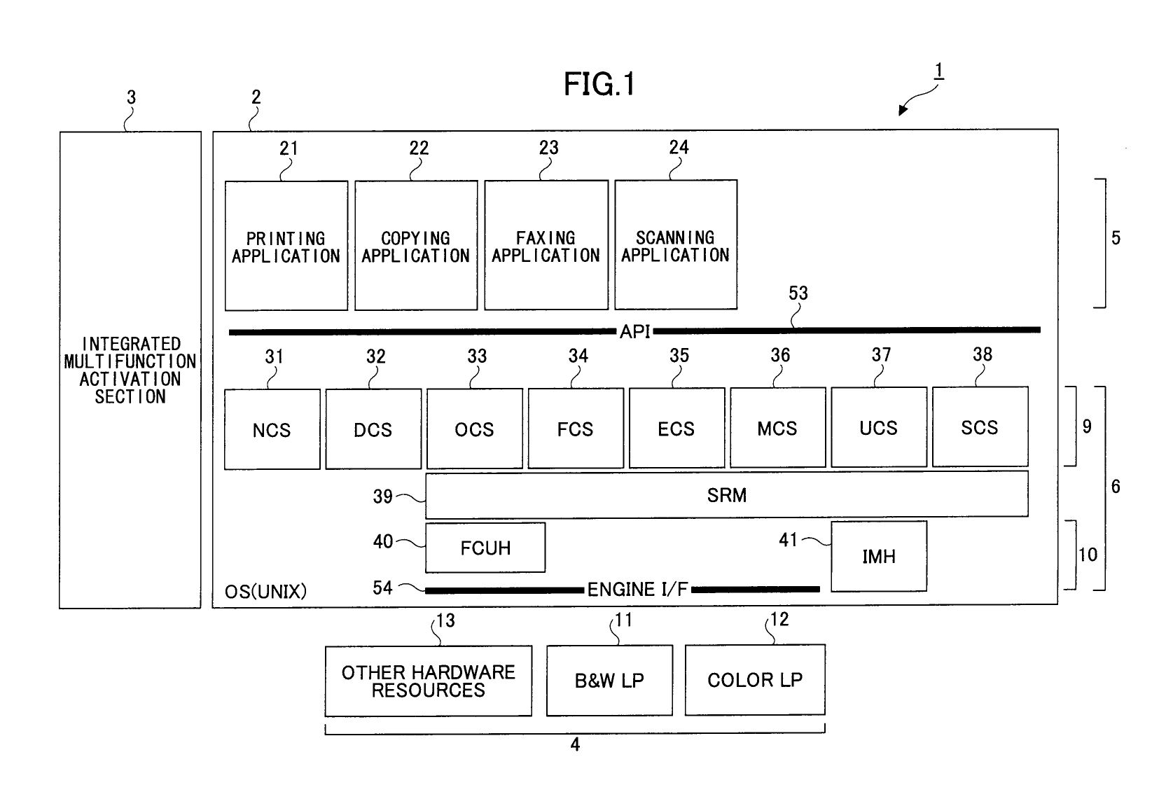

A description is given below, with reference to FIGS. 1 through 13 of embodiments of the present invention. The followings are descriptions of an image forming apparatus (e.g., integrated multifunctional machine) 1 to which an embodiment of the invention is applied.

### <System Configuration>

### (Overall Configuration)

FIG. 1 is a configuration diagram of an image forming apparatus according to an embodiment of the invention. The image forming apparatus 1 includes a software group 2, an integrated multifunctional activation section 3, and hardware resources 4.

On supplying the power to the image forming apparatus 1, the integrated multifunctional activation section is first activated. The integrated multifunctional activation section 3 then subsequently activates an application layer 5 and a platform 6. For example, the integrated multifunctional activation section 3 reads programs of the application layer 5 and the platform 6 from a hard disk drive (hereinafter abbreviated as “HDD”) and the like, and transfers the retrieved programs to a memory region, thereby activating the application layer 5 and the platform 6.

Hardware resources 4 include a black-and-white laser printer (hereinafter also abbreviated as “B&W LP”) 11, a color laser printer (hereinafter also abbreviated as “color LP”), and other hardware resources 13 such as a scanner and a facsimile.

The software group 2 includes the application layer and the platform 6 activated on an operating system (hereinafter abbreviated as “OS”) such as UNIX (registered trademark). The application layer 5 includes programs involving unique image forming processing for individual user services such as printing, copying, faxing, and scanning.

The application layer 5 includes a printing application 21, a copying application 22, a faxing application, and a scanning application 24.

The platform 6 includes a control service layer 9 translating processing requests obtained from the application layer 5 and generating allocation requests to allocate the hardware resources 4, a system resource manager (hereinafter abbreviated as “SRM”) 39 managing one or more of the hardware resources 4 so as to control the allocation requests obtained from a control service layer 9, and a handler layer 10 managing the hardware resources 4 based on the allocation requests obtained from the SRM 39.

The control service layer 9 includes at least one of the service modules including a network control service (NCS) 31, a delivery control service (DCS) 32, an operation panel control service (OCS) 33, a fax control service (FCS) 34, an engine control service (ECS) 35, a memory control service (MCS) 36, a user information control service (UCS) 37, and a system control service (SCS) 38.

Note that the platform 6 includes an API 53 to receive the processing requests from the application layer 5 based on a predefined function. The OS carries out parallel execution of the software programs as processes of the application layer 5 and the platform 6.

The process of the NCS 31 provides common services to applications that need to use network I/O functions, and serves as an intermediary function when sorting out the data received over the network to the applications or transmitting the data generated from the applications to the network.

For example, the NCS 31 controls data communications with a networking device connected over the network by running a Hyper Text Transfer Protocol Daemon (httpd), based on a protocol called a Hyper Text Transfer Protocol (HTTP).

The process of the DCS 32 controls the delivery of accumulated documents. The process of the OCS 33 controls an operation panel communicating information between an operator (user) and the image forming apparatus 1. The process of the FCS 34 supplies APIs from the application layer 5 for carrying out a FAX transmission or its reception utilizing a PSTN or an ISDN, registering or referring to corresponding fax data managed by a back-up memory, reading a fax-transmitted data, and printing a fax-received data.

The process of the ECS 35 controls an engine section of the black-and-white laser printer 11, the color laser printer 12, and the hardware resources 13. The process of the MCS 36 controls the allocation and deallocation of memory, the HDD, and the like. The process of the UCS 37 manages user's information.

The process of the SCS 38 carries out processing such as managing the applications, controlling an operation unit, a system screen display and an LED display, and managing the hardware resources.

The processes of the SRMs 39 and 38 both control the system and manage the hardware resources 4. For example, the process of the SRM 39 controls the system and manages the hardware resources 4 such as the black-and-white laser printer 11 and the color laser printer 12 based on the allocation requests received from the higher layer that utilizes the hardware resources 4.

More specifically, the process of the SRM 39 determines whether the requested hardware resource 4 is available; that is, whether or not the hardware resource 4 requested has been allocated to other requests. If the requested hardware resource 4 is available, the process of the SRM 39 notifies the higher layer of information indicating that the requested hardware 4 is available. The process of the SRM also schedules a time table to allocate the hardware resources 4 for the requests assigned from the higher layer, and carries out requested operations. That is, the process of the SRM 39 causes the printer engine to convey sheets of paper, form images thereon, secure memory, and generate files.

The handler layer 10 includes a fax control unit handler (FCUH) 40 controlling a fax control unit (FCU) described later, and an image memory handler (IMH) 41 managing the allocation of memory to a requested process and the memory allocated to a process. The SRM 39 and FCH 40 transmits the processing requests to the hardware resources 4 by activating an engine I/F 54 that enables the SRM 39 and FCH 40 to transmit the processing requests to the hardware resources 4 based on a predefined function.

In the image forming apparatus 1, all the necessary processing common to the applications can be processed in the platform 6 in an integrated fashion.

### (Hardware)

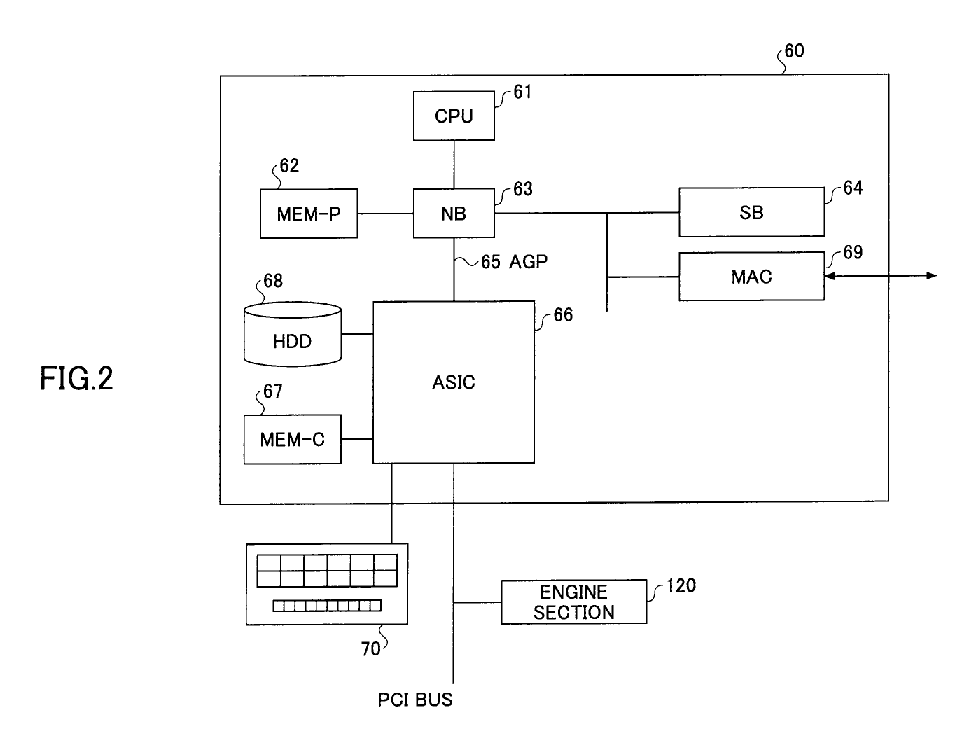

FIG. 2 is a configuration diagram of an image forming apparatus according to an embodiment of the invention. The image forming apparatus 1 includes a controller 60, an operation panel 70, the FCU 80, the MLC 10, and an engine section 120.

The controller 60 includes a CPU 61, a system memory (MEM-P) 62, a north bridge (NB) 63, a south bridge (SB) 64, an ASIC 66, a local memory (MEM-C) 67, a MAC 69, and an HDD 68.

The operation panel 70 is connected to the ASIC 66 of the controller 60. The engine section (including scanner and plotter engines) 120 is connected to the ASIC of the controller 60 via a PCI bus.

In the controller 60, the ASIC 66 is connected with the local memory 67 and the HDD 68, and also connected with the CPU 61 with the NB 63, that is, a CPU chipset. The CPU 61 is connected with the ASIC 66 with the NB 63 so as to continue processing even in a case where a type of an interface the CPU 61 employs is not disclosed.

Note that the ASIC 66 and the NB 63 are not connected via the PCI bus but are connected via an accelerated graphics port (AGP) 65. Accordingly, the ASIC 66 and the NB 63 are connected not via the low speed PCI bus but via the high speed AGP 65 in order to control the execution of one or more processes of the application layer 5 and the platform 6 as shown in FIG. 1, thereby preventing lowering the performance of the executed processes.

The CPU 61 controls the entire image forming apparatus 1. The CPU 61 executes the processes of the NCS 31, DCS 32, OCS 33, FCS 34, ECS 35, MCS 36, UCS 37, SCS 38, SRM 39, FCUH 40 and IMH 41 on the OS, and activates the printer application 21, the copying application 22, the faxing application 23, and the scanning application 24.

The NB 63 is a bridge to connect the ASIC 66 to the CPU 61, the system memory 62, and the SB 64. The system memory 62 may be utilized as an image memory for the image forming apparatus 1. The SB 64 is a bridge to connect the NB 64 to a ROM, the PCI bus, and peripherals. The local memory (MEM-C) 67 is utilized as a copying image buffer or a code buffer.

The MAC 69 is one of the peripherals to control the communication over Ethernet.

### <Operation>

### (Overall Operation)

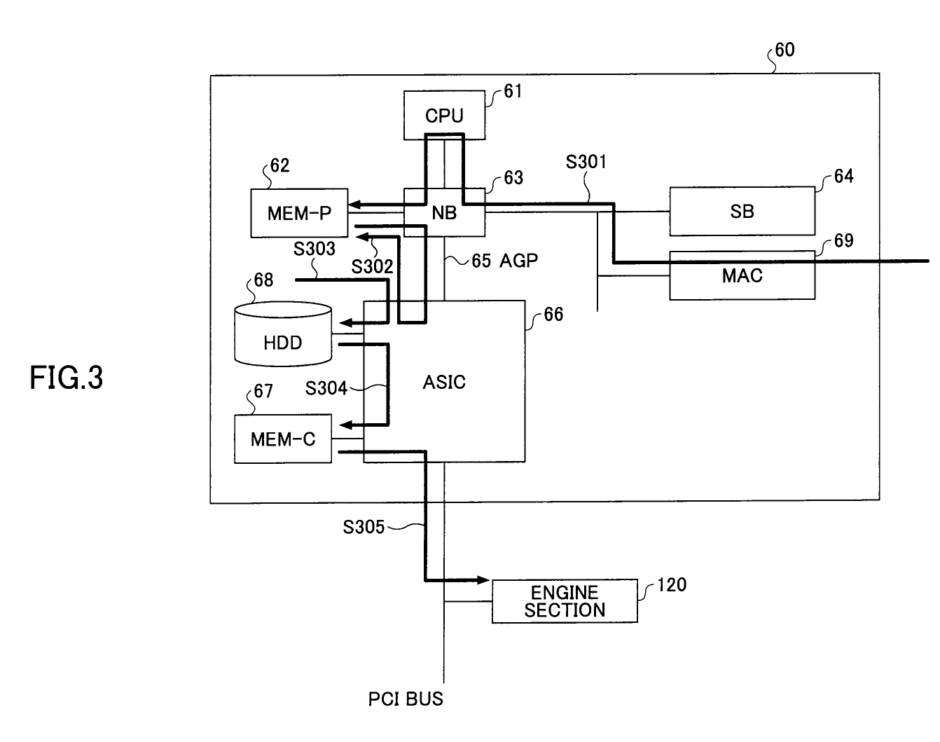

FIG. 3 is a diagram illustrating a data flow when inputting and outputting image data in the image forming apparatus according to the embodiment of the invention. First, an overall data flow is described prior to detailed descriptions of individual processing steps.

Image data are input from an external device and stored in the MEM-P 62 via the MAC 69, the NB 63, and the CPU 61 at step S301. The image data are temporarily recorded in the MEM-P 62 to cancel out the difference between processing rates of forming and scanning images. Note that the MEM-P 62 is utilized as an imaging memory (input image memory), and the MEM-C 67 is utilized as a copying image buffer (output image memory), in other words, a code buffer.

The image data stored at Step S302 are compressed by the ASIC 66, and the compressed data are stored in the MEM-P 62. Note that the image data are compressed so as to efficiently utilize the image memory having a limited capacity. The image data in the MEM-P 62 are configured to be accessible by the CPU 61. Thus, the image data in the MEM-P 62 can be subjected to various types of processing such as image compression processing, pixel skipping processing, and image cutting processing. These types of processing on the image data stored in the MEM-P 62 can be carried out by writing the data in a registry of the memory controller 60. The processed image data are stored in the MEM-P 62 again.

The compressed data that are stored at Step S303 are transferred to be stored in an HDD 68, that is, an accumulation region. The HDD 68 is provided separately from the MEM-P 62, because numerous image data are stored in the MEM-P 62. A hard disk drive (HDD 68 in this case) needs no external power source and is capable of storing the images permanently. Note that the image data (compressed data) stored in the HDD 68 may be utilized for collecting information in order to carry out remote maintenance on the image forming apparatus.

Referring back to FIG. 3, the compressed data that are stored in the HDD 68 at Step S304 are transferred to be stored in an MEM-C 67.

The compressed data stored in the MEM-C 67 at Step S305 are expanded (decompressed) via the ASIC 66, and the expanded data are then output to the engine section (hereinafter also called “print engine”) 120.

In the image forming apparatus 1 according to the embodiment, the compressed data stored in the accumulation region are transferred to the output image memory without expansion (decompression). Instead, the compressed data are expanded (decompressed) after the data have been output from the output image memory, and the expanded data are supplied to the print engine 120. Accordingly, since the image data are still handled in codes (i.e., compressed data) in the output image memory, the amount of data processed in the output image memory can be reduced in the printing processing, thereby storing an increased amount of data in the output image memory. This exhibits high storage capacity efficiency. Specifically, since the image data are handled in codes and the sizes of the compressed data (codes) are thus still small in the output image memory, the output image memory are provided with sufficient space for storing or holding a large number of the codes (compressed data) within a prescribed time duration. In addition, the number of times the resources are allocated can also be reduced.

If the amount of data processed in the output image memory is small, consumption of system resources can be reduced accordingly. Thus, an adverse effect due to resource interference between various operations or processing can be reduced to thereby improve the performance of a system. Further, the resource interference between other necessary resources or duration of allocating such resources may also be lowered to thereby reduce adverse effects on other types of processing during multiple operations (MA operations).

### (Compression and Expansion)

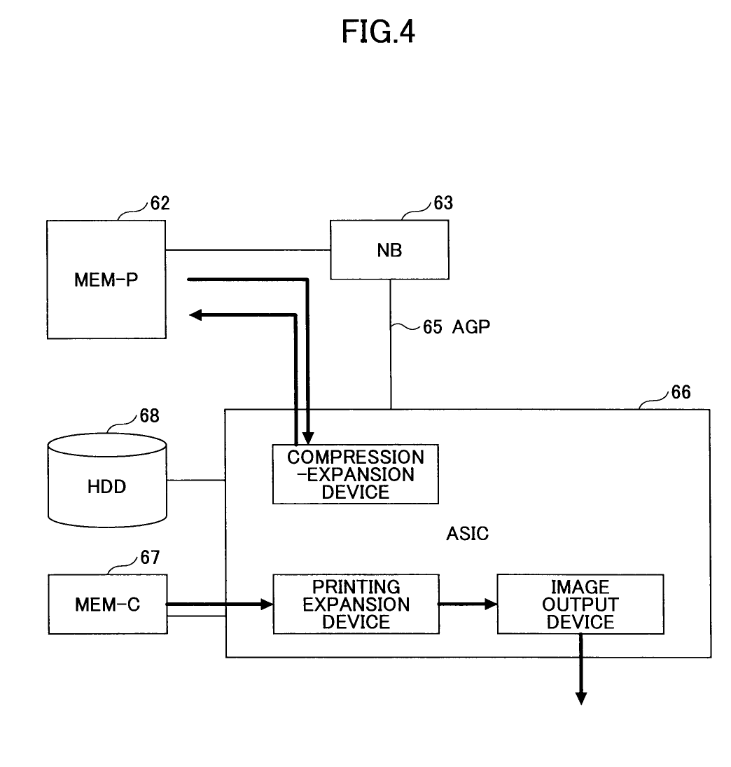

FIG. 4 is a diagram illustrating an ASIC 66 in the image forming apparatus according to the embodiment of the invention. At the aforementioned Steps S302 and S305, the image data are compressed and expanded (decompressed) by an ASIC 66.

The ASIC 66 includes a compression-expansion device compressing the image data and expanding the compressed data, a printing expansion device utilized for expanding the compressed data, and an image output device utilized as an output port for transferring the image data to the engine. The ASIC according to the embodiment includes four printing expansion devices and two compression-expansion devices. The four printing expansion devices are utilized when the compressed data are output from the output image memory to the print engine 120 whereas the two compression-expansion devices are utilized when the compressed data are transferred from the accumulation region (i.e., HDD 68) to the memory (i.e., MEM-C 67). The four printing expansion devices are used specifically when the four colors of CMYK in images are simultaneously processed. The two compression-expansion devices are not used in this case.

### (Details of Each Operation)

Next, details of the operation (steps) are described below.

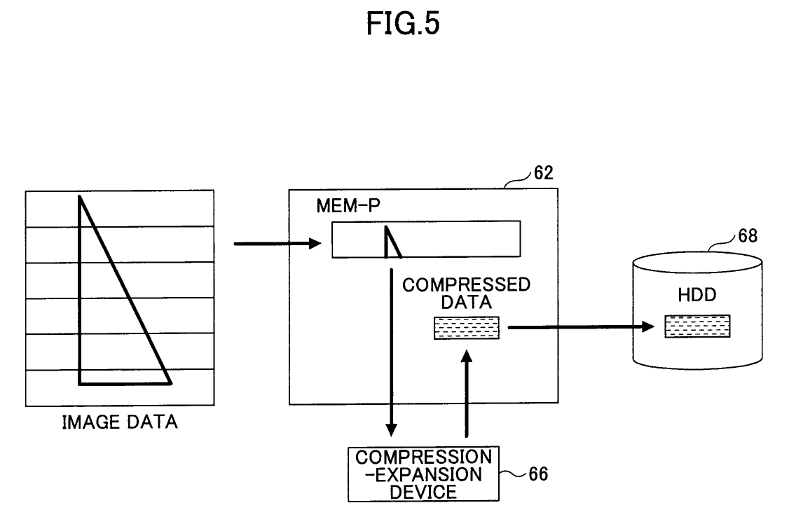

FIG. 5 is a diagram illustrating a process in which the image data are compressed and the compressed data are stored in the accumulation region (HDD 68) at Steps S302 and 5303. The image data stored are deployed in the MEM-P 62, and the deployed data are divided into segments each having a predetermined size and then compressed by the compression-expansion device of the ASIC 66. The compressed data are deployed in the MEM-P 62, and the deployed data are transferred to be stored in the HDD 68.

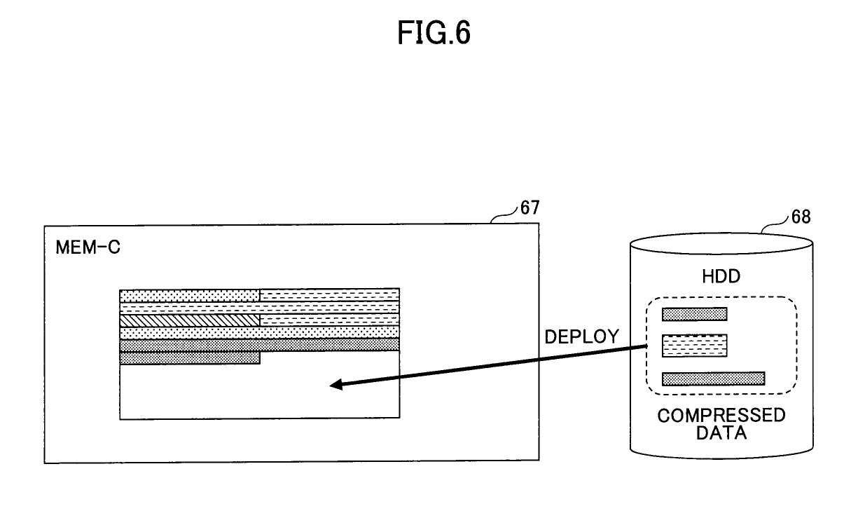

FIG. 6 is a diagram illustrating a process in which the compressed data stored in the accumulation region (HDD 68) are transferred to and deployed in an output image memory (a first output image memory) (MEM-C 67) at Step S304. If the document is in color and has an extra-long length, the size of the image data will be enormous (e.g., 2.4 GB in a case where the document size is 914.4 mm*15,000 mm). In such a case, even if the image data are compressed, the compressed data may not be small enough to be fully loaded into the memory. Accordingly, the compressed data may need to be divided into segments each having a predetermined size to be loaded into the memory. The compressed data segments (hereinafter also referred to as “codes”) are sequentially transferred (deployed) to available space (free space) of the MEM-C 67 or an area of the MEM-C 67 from which the data have already been read. Note that the size of each segment (code) of the compressed data to be transferred may be compared with the size of the free space at the time the MEM-C 67 has obtained the free space to determine whether to transfer a subsequent compressed data segment (code) from the HDD 68 to the MEM-C 67. However, since the sizes of the compressed data segments are predetermined in this embodiment, which of the compressed data segments (codes) to be transferred are determined at the initial settings in the image forming apparatus 1 according to the embodiment of the invention. Accordingly, it may not be necessary to determine whether to transfer the subsequent compressed data segment (code) to the memory during printing. As a result, memory load can be reduced during printing. More specifically, the number of compressed data segments (codes) to be transferred is computed based on the size of the free space in the memory (MEM-C 67) and the size of the compressed data segment (code). Since a compressed data segment (code) has a variable-length code, the number of bits corresponding to the variable-length code needs to be computed. Further details of this computation are described below.

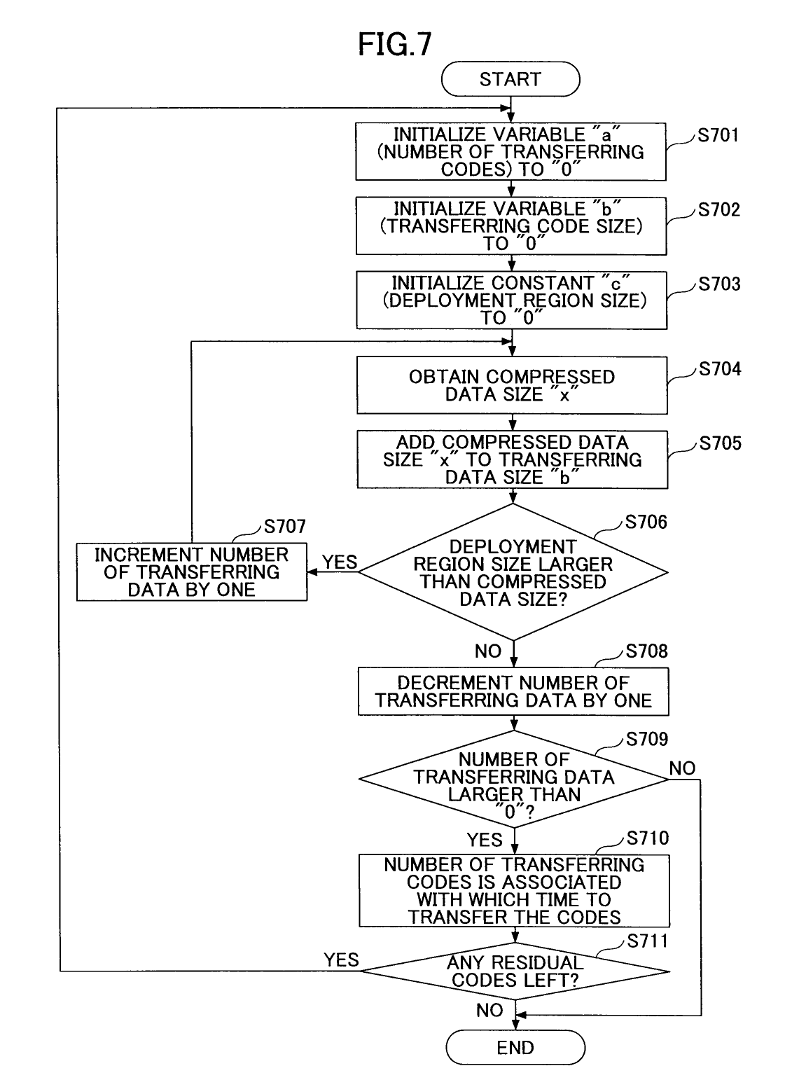

FIG. 7 is a flowchart illustrating a process in which the number of the compressed image data to be transferred to the output image memory is computed. Following the processes in the flowchart, the number of compressed data segments to be transferred to the output image memory (MEM-C 67) has been determined, and transferring the compressed data segments is controlled (by a transfer control section). The processes of the flowchart are conducted by an IMH 41 when the compressed data segments are transferred from the HDD 68 to the MEM-C 67. The IMH 41 is an image memory handler that manages the allocation of memory to the processes, and also manages memory allocated to the processes. The details of the IMH 41 are described later.

At Step S701, a variable “a” is defined as the “number of transferring codes (number of segments of the compressed data to be transferred)” to be transferred to the output image memory (MEM-C 67), and the variable “a” is initialized to zero.

At Step S702, a variable “b” is defined as a “transferring code size”, that is, size of a code (compressed data segment) to be transferred to the output image memory (MEM-C 67), and the variable “b” is initialized to zero.

At Step S703, a constant “c” is defined as a “deployment area size” and obtains the size of the area in which the codes are deployed is obtained. The “deployment area size” indicates the capacity of the deployment area of the output image memory (MEM-C 67) in which the codes (compressed data segments) can be deployed. Note that the deployment area size is predetermined, and the predetermined size of the deployment area is obtained at Step S703.

At Step S704, a first code (first segment of compressed data segments) is obtained as a compressed data size “x” from an entire compressed data having 11 codes. Note that the “compressed data size” is obtained from the compression-expansion device of the ASIC 66 while the image data are being compressed by the compression-expansion device, and the compressed data size is registered to the HDD 68 as file system information. Accordingly, the size registered as the file system information can be utilized as the compressed data size.

At Step S705, the “compressed data size” obtained at the preceding step is added to the “transferring data size” (b+x).

At step S706, whether the “deployment area size” exceeds the “transferring data size” is determined (c>b?) . This determination process determines the number of compressed data that can be transferred. In this process, the additional “compressed data size” is added as the compressed data segments that can be transferred unless the “transfer data size” exceeds the “deployment area size”. In this case, the process goes to Step S707.

At Step S707, the number of compressed data segments to be transferred is incremented by one (a+1).

Thereafter, the process goes back to the Step S704. At 5704, the compressed data size of the next code (second segment of compressed data) is obtained as the compressed data size “x”. At Step S705, the “compressed data size” obtained at a preceding step is added to the “transferring data size” (b+x), and at Step S706, whether the “deployment area size” exceeds the “transfer data size” is determined again. At this step (S706), if the “deployment area size” exceeds the “transfer data size”, no more codes (segments of compressed data) can be added as the compressed data segments that can be transferred. In this case, the process goes to Step S708.

At Step S708, the number of codes (compressed data segments) to be transferred is decremented by one (a−1). The number of codes to be transferred is decremented so as to decrement the number of exceeded codes (exceeded segment of compressed data).

At step S709, whether the “number of codes to be transferred” exceeds zero is determined (a>0?). This process is provided in a case where there are no codes (compressed data segments) to be transferred.

At Step S710, the number of codes (compressed data segments) to be transferred is associated with what number of times one set of codes (i.e., compressed data composed of plural codes) are transferred (hereinafter referred to as “transferring time” such as first, second, third, and fourth transferring time) to the output image memory (MEM-C 67). For example, in a case where the number of compressed data segments to be transferred is (a=3), the number of compressed data segments that can be transferred to the output image memory (MEM-C 67) at the first transferring time is determined as “3”.

At Step S711, whether there are remaining codes of compressed data segments (i.e., codes that have not been transferred) is determined. If there are, the process goes back to S701 to conduct the processes S701 to S711 again. However, Step S703 can be skipped as the “deployment area size” has already been obtained. Returning back to Step S710, in a case where the number of codes (compressed data segments) to be transferred is (a=4), the number of codes (compressed data segments) that can be transferred to the output image memory (MEM-C 67) at the second transferring time is determined as “4”.

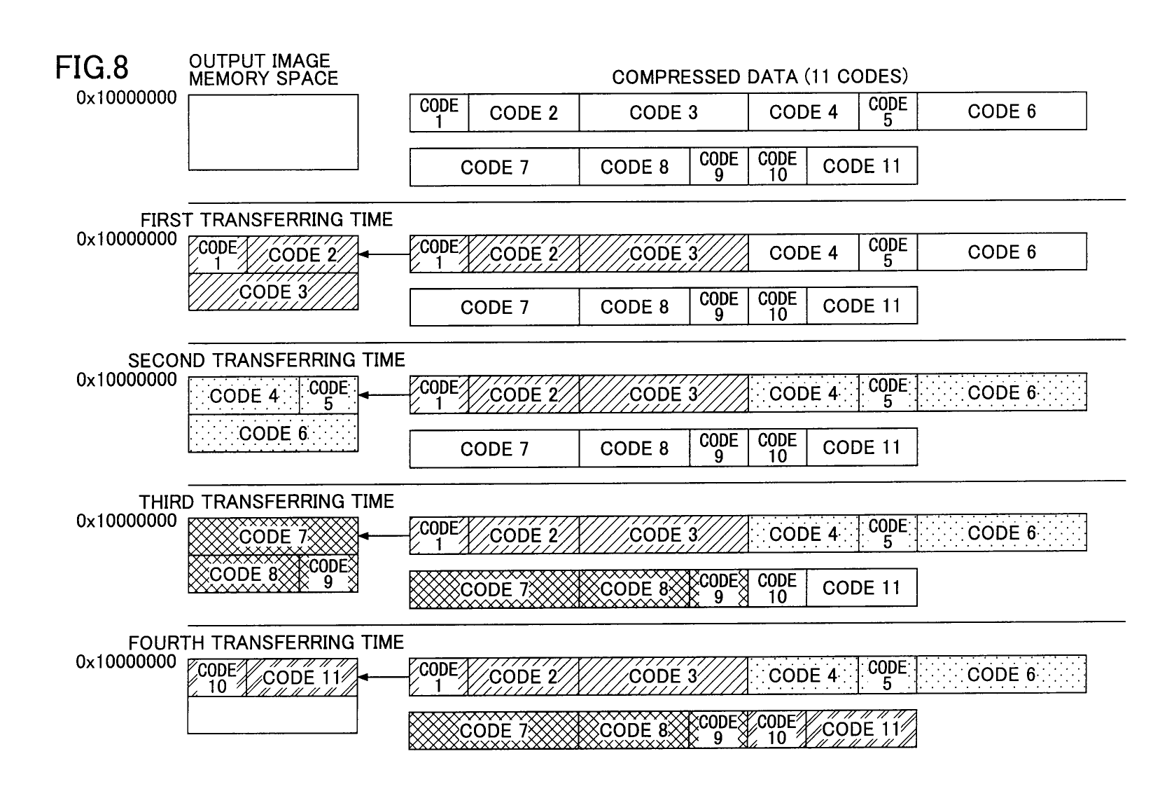

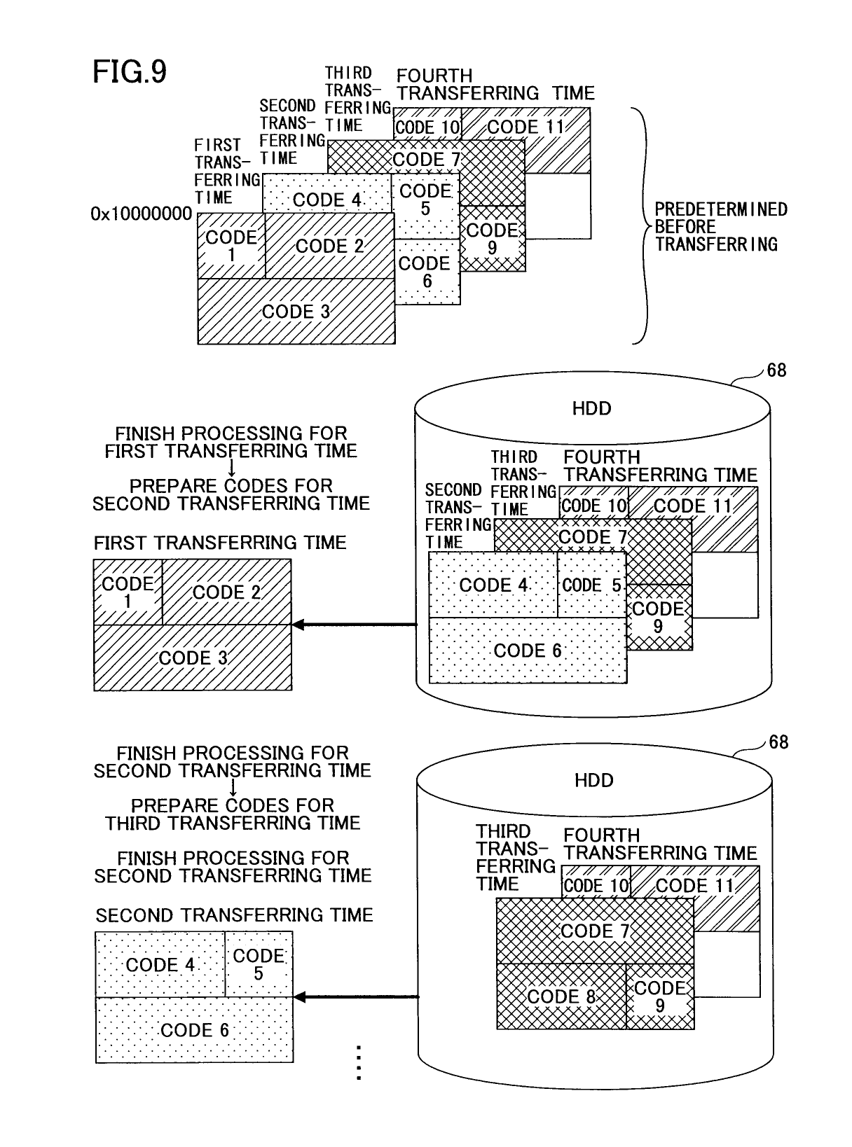

FIG. 8 is a diagram illustrating a profile in which the number of codes (compressed data segments) to be transferred to the output image memory is determined. In this example, the compressed data includes 11 codes, and the number of codes (compressed data segments) to be transferred is determined as three at the first transferring time (codes 1, 2, 3), as three at the second transferring time (codes 4, 5, 6), as three at the third transferring time (codes 7, 8, 9), and as two at the fourth transferring time (codes 10, 11). Each of segments of the compressed data is accompanied with a corresponding code number. FIG. 9 is a diagram illustrating one example of a profile in which the codes are sequentially processed. Since the size of each code stored in the HDD 68 has already been determined, the location (i.e., address) of the memory (i.e., output image memory) to which the code is deployed is predetermined each time the code is read. Note that in this embodiment, what number of transferring time the codes are transferred can be specified by the code order; however, a code number can also be specified by what number of transferring time the codes are transferred.

Thus, in the image forming apparatus 1 according to this embodiment, the number of compressed data segments (codes) to be transferred can be determined at initial settings at the time the compressed data segments (codes) are transferred.

After the first set of the codes (compressed data segments) has been transferred to the output image memory at the first transferring time, a second set of the codes (compressed data segments) is prepared to be transferred thereto. The time at which the second set of the codes to be transferred to the output image memory can be determined at any arbitrary time. One example may include the time at which the deployment area obtains available space after the first set of codes (compressed data segments) has been output (transferred) to the printing expansion device of the ASIC 66. In this process, the size of the code (compressed data segments) already transferred (output) is subtracted from the size (constant c) of the deployment area each time the code (compressed data segment) has been transferred to the deployment area. Every time a code (compressed data segment) has been transferred from the image output device of the ASIC 66 to the printing expansion device of the ASIC 66 and interrupt notification has been given to the IMH 41, the size of the code (compressed data segment) that has been already output to the printing expansion device of the ASIC 66 is also notified to the IMH 41. Thus, the size of the code (compressed data segment) already output to the printing expansion device of the ASIC 66 can be added to the constant c of the deployment area. From the second transferring time onwards, a subsequent code can be transferred based on the incremented or decremented constant value c.

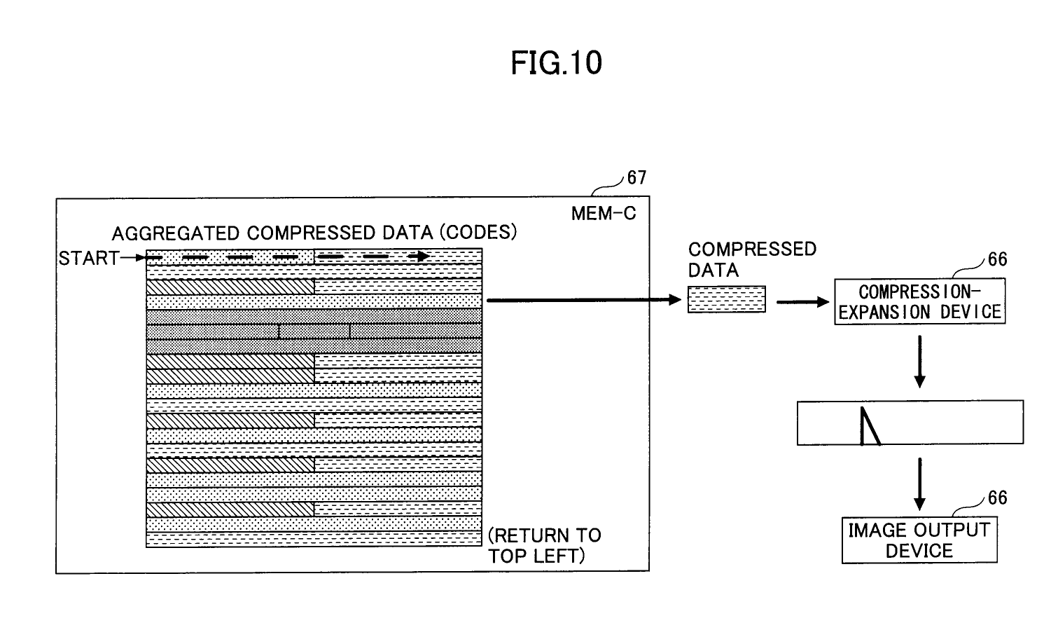

FIG. 10 is a diagram illustrating a process in which the compressed data segments (codes) are read and output to the print engine. Aggregated compressed data segments (codes) are read in a direction indicated by an arrow from “START” position. The codes (compressed data segments) read from the output image memory are each expanded (decompressed) by the printing expansion device (compressed-expansion device) of the ASIC 66, and the expanded (decompressed) data (codes) are each output to the image output device of the ASIC 66. Having read the complete aggregated compressed data segments from the output image memory, another set of codes (compressed data segments) is transferred to the output image memory to be read in the direction indicated by the arrow from “START” position again.

### (Progress Management of Processing)

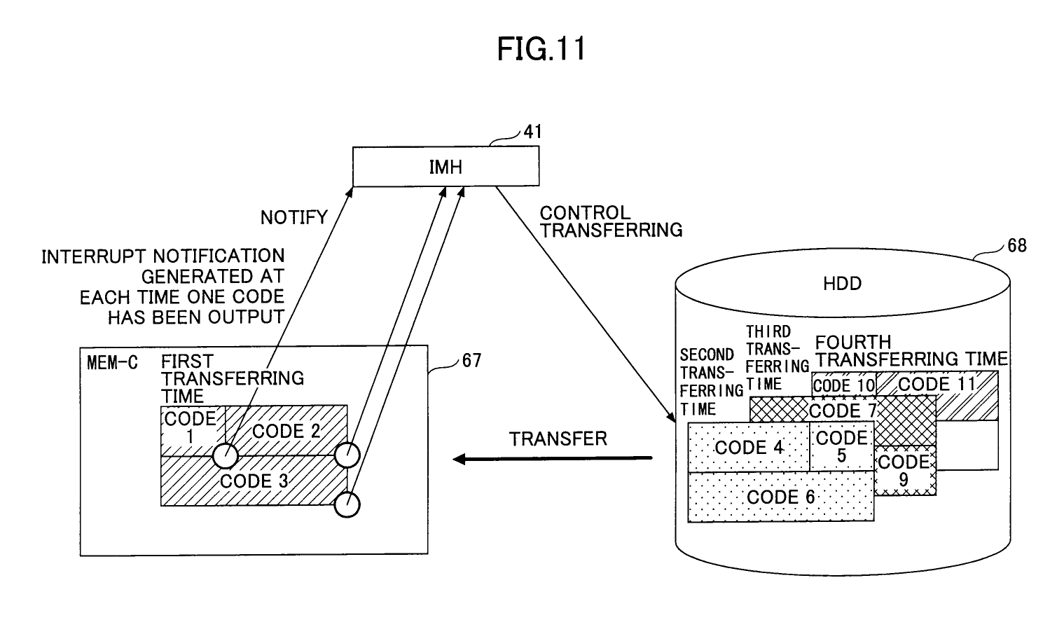

FIG. 11 is a diagram illustrating a process in which the image memory handler manages progress of output processing. As described earlier, the IMH 41 is an image memory handler managing allocation of the memory to the processes, and also managing the allocated memory to the processes. Since the ASIC 66 notifies an interrupt to IMH 41 each time one code has been output from the image output device to the printing expansion device of the ASIC 66, the IMH 41 controls transferring of the codes (compressed data segments) from the accumulation region (HDD 68) to the output image memory (MEM-C 67) in response to the notification. The IMH 41 controls transferring of the codes (compressed data segments) as follows; after the first set of the codes (compressed data segments) is transferred to the print engine 120 at the first transferring time, a second set of the codes (compressed data segments) is prepared to be transferred. The time at which the second set of the codes is to be transferred can be determined at any arbitrary time. One example of such time may be the time at which the deployment area obtains available space (free space) because the first set of codes (compressed data segments) has been transferred to the printing expansion device of the ASIC 66. As described earlier, the size of the code (compressed data segment) already deployed is subtracted from the size (constant c) of the deployment area each time the code (compressed data segment) has been deployed in the deployment area. Whenever one code (compressed data segment) has been transferred from the image output device of the ASIC 66 and interrupt notification has been given to the IMH 41, the size of the code (compressed data segment) that has been already output is also notified to the IMH 41. Thus, the size of the code (compressed data segment) already output can be added to the constant c of the deployment area. From the second transferring time onwards, a subsequent code can be transferred based on the incremented or decremented constant value c.

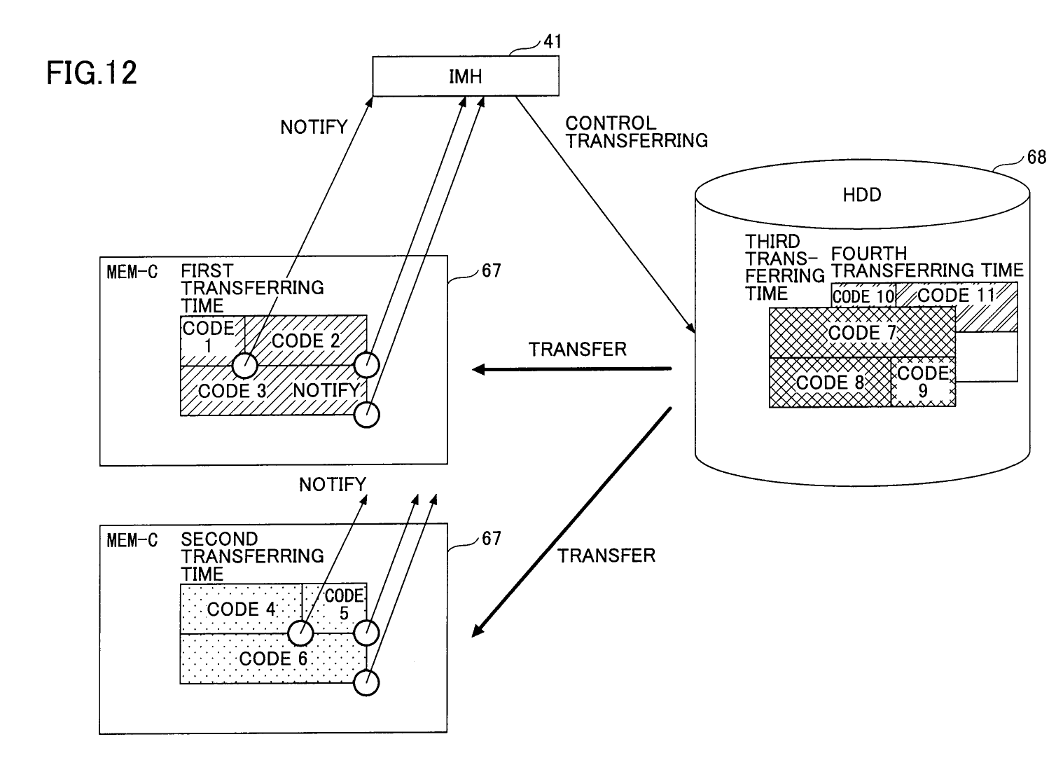

FIG. 12 is a diagram illustrating another example (modification 1) of the process in which the image memory handler manages the progress of output processing of the compressed data segments (codes). As shown in FIG. 12, the image forming apparatus according to the modification 1 includes a second output image memory (another MEM-C 67) in addition to the first output image memory. In this configuration, a second set of codes (compressed data segments) to be transferred subsequent to the first set of codes is transferred from the HDD 68 to the second output image memory (MEM-C 67) after the first set of codes is output from the first output image memory (MEM-C 67) to the print engine 120.

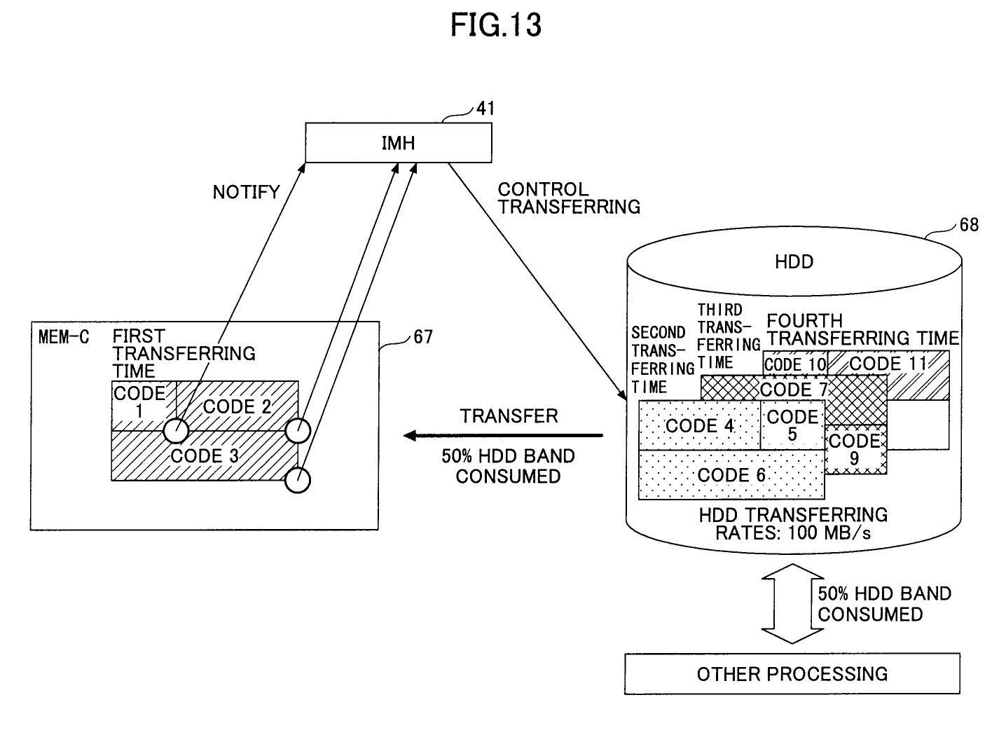

FIG. 13 is a diagram illustrating still another example (modification 2) of the process in which the image memory handler (IMH 41) manages the progress of output processing of the compressed data segments (codes). As shown in FIG. 13, in the image forming apparatus according to the modification 2, the IMH 41 controls transferring of the codes (compressed data segments) from the accumulation region (HDD 68) to the output image memory (MEM-C 67) based on time consumed for other types of processing. For example, in a case where a processing rate of reading codes requires 50 MB/sec, and a transferring rate from the HDD 68 to MEM-C 67 is 100 MB/sec, the HDD 68 still has capacity that can be allocated to a process requiring a transferring rate of 50 MB/sec. Thus, this capacity of the HDD 68 can be allocated to other types of processing. Further, in FIG. 13, in a case where a second output memory (another MEM-C 67) is added to the image forming apparatus 1 according to the modification 2, the IMH 41 can control transferring of the codes (compressed data segments) from the HDD 68 to first and second output memories based on time in which the compressed data segments (codes) are transferred from the HDD 68 to the first and second output memories.

In the image forming apparatus 1 according to the embodiments, the compressed data segments stored in the accumulation region are transferred to the output image memory without expanding the compressed data segments. Instead, the compressed data segments are expanded after the compressed data segments have been output from the output image memory and the expanded compressed data segments are then supplied to the print engine 120; that is, the compressed data segments are expanded only after the compressed data segments have been output from the output memory. Accordingly, since the image data are handled in codes (i.e., compressed data segments) 1, the amount of data processed in the output image memory is small, thereby efficiently utilizing the capacity of the output image memory. That is, since the sizes of the compressed data segments (codes) are small, sufficient space can be provided for a large number of the compressed data segments in the output image memory within a prescribed time period, thereby reducing the number of times the resources are allocated.

Accordingly, the embodiments of the present invention may provide the image forming apparatus, method of transferring image data, and program product for causing a computer to implement the method of transferring image data in which the image data subjected to output are compressed as codes and the codes (compressed data segments) are handled in the output image memory and are only expanded after the codes have been output from the output image memory and the expanded codes are then supplied to the print engine, thereby improving efficiency in printing the image data.

Note that any arbitrary combinations, expressions, or rearrangement, as appropriate, of the aforementioned constituting elements and so forth applied to a method, device, system, computer program, recording medium, and the like are all effective as and encompassed by the embodiments and modifications of the present invention.

According to the embodiments of the present invention, there are provided the image forming apparatus, method of transferring image data, and program product for causing a computer to implement the method of transferring an image data in which the image data subjected to output are compressed as codes, the codes are handled in the output image memory, and the codes are expanded after the codes have been output from the output image memory and the expanded codes are then supplied to the print engine, to thereby improve efficiency in printing the image data.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority or inferiority of the invention. Although the embodiment of the present invention has been described in detail, it should be understood that various changes, substitutions, and alterations could be made hereto without departing from the spirit and scope of the invention.

This patent application is based on Japanese Priority Patent Application No. 2008-296032 filed on Nov. 19, 2008, the entire contents of which are hereby incorporated herein by reference.

What is claimed is:

1. An image forming apparatus comprising:
a storage section configured to store first compressed data obtained by compressing image data;
a first output image memory having a deployment area in which the first compressed data transferred from the storage section are deployed;
a transferring control section configured to control transferring of the first compressed data from the storage section to the first output image memory;
an expansion section configured to obtain the first compressed data deployed in the deployment area of the first output image memory to expand the obtained first compressed data; and
a print engine to which the expanded data expanded by the expansion section are supplied,
wherein the transferring control section controls the transferring of the first compressed data to be transferred from the storage section to the first output image memory based on capacity of the deployment area of the first output image memory and a size of the first compressed data.

2. The image forming apparatus as claimed in claim 1,
wherein the first compressed data include a plurality of compressed codes, the transferring control section transfers, when the size of the first compressed data that include the plurality of compressed codes is larger than the capacity of the deployment area of the first output image memory, the compressed codes from the storage section to the first output image memory in two or more transfers, and wherein, before starting to transfer the compressed codes from the storage section to the first output image memory, the transferring control section determines a total number of transfers, the number of compressed codes to be transferred at each transfer, and a plurality of addresses in the first output image memory to each of which a corresponding part of the compressed codes is deployed.

3. The image forming apparatus as claimed in claim 1, further comprising:
a second output image memory to which the transferring control section controls transferring of second compressed data obtained by compressing another image from the storage section; and
a progress management section configured to manage progress of output processing of the first compressed data deployed in the deployment area of the first output image memory to the print engine,
wherein the transferring control section controls transferring of the second compressed data from the storage section to the second output image memory based on the progress of output processing of the first compressed data deployed in the deployment area of the first output image memory to the print engine managed by the progress management section.

4. The image forming apparatus as claimed in claim 3,
wherein the transferring control section controls transferring of the second compressed data from the storage section to the second output image memory based on a time period in which the first compressed data in the deployment area of the first output image memory are being output from the first output image memory to the print engine.

5. A method of transferring image data in an image forming apparatus including a storage section configured to store compressed data obtained by compressing image data, an output image memory having a deployment area in which the compressed data transferred from the storage section are deployed, and a print engine, the method comprising:
controlling transferring of the compressed data from the storage section to the output image memory based on capacity of the deployment area of the output image memory and a size of the compressed data;
expanding the compressed data retrieved from the deployment area of the output image memory; and
supplying the expanded data to the print engine.

6. The method as claimed in claim 5,
wherein the step of controlling includes transferring a plurality of compressed codes included in the compressed data stored in the storage section to the output image memory in two or more transfers when the size of the compressed data is larger than the capacity of the deployment area of the output image memory, and the step of controlling further includes determining a total number of transfers, the number of the compressed codes to be transferred at each transfer, and a plurality of addresses in the output image memory to each of which a corresponding part of the compressed codes is deployed before starting to transfer the compressed codes from the storage section to the output image memory.

7. A computer-readable program product for causing a computer to implement the method of transferring image data as claimed in claim 5.
